(19) United States
(12) Patent Application Publication
(10) Pub. No.: US 2006/0184968 A1
(43) Pub. Date: Aug. 17, 2006

(54) Automatic content update for a target device

(76) Inventors: Richard M. Clayton, Phoenix, AZ (US); Michael T. Gaumond, Scottsdale, AZ (US); Jeffrey S. Stinson, Mesa, AZ (US); David E. Ulmer, Phoenix, AZ (US); Jean-Marc A. Villevieille, Phoenix, AZ (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/296,977

(22) Filed: Dec. 8, 2005

Related U.S. Application Data
(60) Provisional application No. 60/651,961, filed on Feb. 11, 2005.
(60) Provisional application No. 60/651,963, filed on Feb. 11, 2005.
(60) Provisional application No. 60/651,960, filed on Feb. 11, 2005.
(60) Provisional application No. 60/651,958, filed on Feb. 11, 2005.
(60) Provisional application No. 60/651,959, filed on Feb. 11, 2005.

(51) Int. Cl. H04N 5/445; G06F 3/00; G06F 13/00; H04N 7/18

(52) U.S. Cl. 725/56; 725/39; 725/75

(57) ABSTRACT

Channel configuration information is sent to a content service, and the content service determines content to be provided in each channel of a set of channels using the channel configuration information. A first target device receives and stores content for the channels. The first target device may transmit at least some of the content to a second target device and automatically update the content stored at the second target device.

### PRIORITY

This application claims the benefit of the following prior filed U.S. patent applications: U.S. Provisional Patent Application No. 60/651,961, filed on Feb. 11, 2005, and entitled, “Seamless Transactions Across Domains And Devices”; U.S. Provisional Patent Application No. 60/651,963, filed on Feb. 11, 2005, and entitled, “Wireless Audio Adapter For Car Radios”; U.S. Provisional Patent Application No. 60/651,963, filed on Feb. 11, 2005, and entitled, “Wireless Audio Adapter For Car Radios”; U.S. Provisional Patent Application No. 60/651,960, filed on Feb. 11, 2005, and entitled, “Zero Install Wireless Audio Adaptor”; U.S. Provisional Patent Application No. 60/651,958, filed on Feb. 11, 2005, and entitled, “Daily Set With Multiple Content Channels”; U.S. Provisional Patent Application No. 60/651,959, filed on Feb. 11, 2005, and entitled, “Supplementing Daily Set With Hot Content”. All of the aforementioned provisional applications are hereby incorporated by reference in their entireties.

### RELATED APPLICATIONS

This application incorporates by reference in their entireties the following U.S. patent applications all of which are assigned to assignee of the present application: Ser. No. TBD (Attorney Docket No BCS03806), entitled “Hot Content Update for a Target Device”; Ser. No. TBD (Attorney Docket No BCS03803), entitled “Wireless Adaptor for Content Transfer”; Ser. No. TBD (Attorney Docket No BCS03804), entitled “Granting Greater Rights to Stored Content”; Ser. No. TBD (Attorney Docket No BCS03802), entitled “Wireless Adaptor for Content Transfer”.

### BACKGROUND

Portable media players and other devices capable of playing media, such as music or videos, are becoming increasingly popular and are typically designed to play the personal media of users. Users tend to use multiple media devices, such as an MP3 player, cellular phone, personal digital assistant, personal computer, and a car audio system, and many of these devices are capable of playing the personal media of the users. However, there is currently no fast and convenient way to transfer content between the multiple devices. These devices tend to have different user interfaces, so it typically is inconvenient for a user to learn and operate each device to play music or other media.

### SUMMARY

According to an embodiment, channel configuration information is sent to a content service, and the content service determines content to be provided in each channel of a set of channels using the channel configuration information. A first target device receives and stores content for the channels. The first target device may transmit at least some of the content to a second target device and automatically update the content stored at the second target device.

### BRIEF DESCRIPTION OF THE DRAWINGS

Embodiments are illustrated by way of example and not limited in the following figure(s), in which like numerals indicate like elements, in which:

FIG. 1 illustrates a system, according to an embodiment;

FIG. 2 illustrates an example of the system of FIG. 1, according to an embodiment;

FIG. 3A illustrates embodiments of a common user interface;

FIG. 3B illustrates examples of content for channels in a channel set;

FIG. 4 illustrates a method for storing content in a target device, according to an embodiment;

FIG. 5 illustrates a method for automatically updating content in a target device, according to an embodiment;

FIG. 6 illustrates a method for automatically updating content in a target device including steps performed by the target device, according to an embodiment;

FIG. 7 illustrates a method for processing user commands at a target device, according to an embodiment; and

FIG. 8 illustrates a computer system that may be used for components of a system, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

1. System Overview

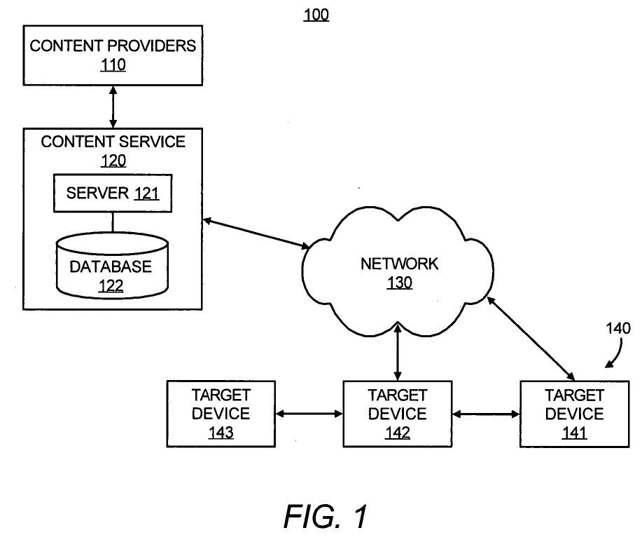

FIG. 1 illustrates a system 100 for content distribution according to an embodiment. The system 100 includes content providers 110, content service 120, network 130 and target devices 140. The content providers 110 include entities configured to provide content that may be played or otherwise consumed by users. Content may include: media, such as, audio, video, text; multimedia that includes two or more of audio, video and text; or other types of data. Examples of content include, but are not limited to, media files, such as MP3 files, other types of audio files, video files, textual music play lists, and other types of files. Examples of content providers 110 may include, but are not limited to, news providers (such as local and cable news television stations), television studios, movie studios, music labels, online music (or other media) providers, and others.

Generally speaking, the content providers 110 provide content to the content service 120, such that the content service 120 may provide several functions. One of the functions includes receiving new content from the content providers 110 on a substantially regular basis. Another of the functions includes making the content received from the content providers 110 available to users. In addition, the content service 120 may receive content from multiple content providers 110 to provide users with a relatively large content selection. Users may obtain the content made available by the content service 120 through, for instance, one or both of subscription services and on-demand services.

The content service 120 may also automatically organize content for users and continually provide new content to users. In addition, the content service 120 may perform other functions, such as billing, user information tracking, historical data tracking, etc. The content service 120 may include a server 121 and a database 122 for storing user information and content. The server 121 may facilitate the downloading of content to the target devices 140 used by the users. It will be apparent to one of ordinary skill in the art that the server 121 may include multiple servers and the database 122 may include multiple databases depending on the size and complexity of the content service 120. For example, to support a relatively large number of users, several servers 121 and databases 122 may be needed to harvest content from the content providers 110 and provide content to users with minimal delay.

The network 130 may represent one or more networks. The network 130 may include one or more of private networks, public networks, such as the Internet, wireless networks, such as satellite and cellular networks, and local area wireless networks, such as WiFi or Bluetooth networks, wired networks, local area networks, wide area networks, and any other type of communication network.

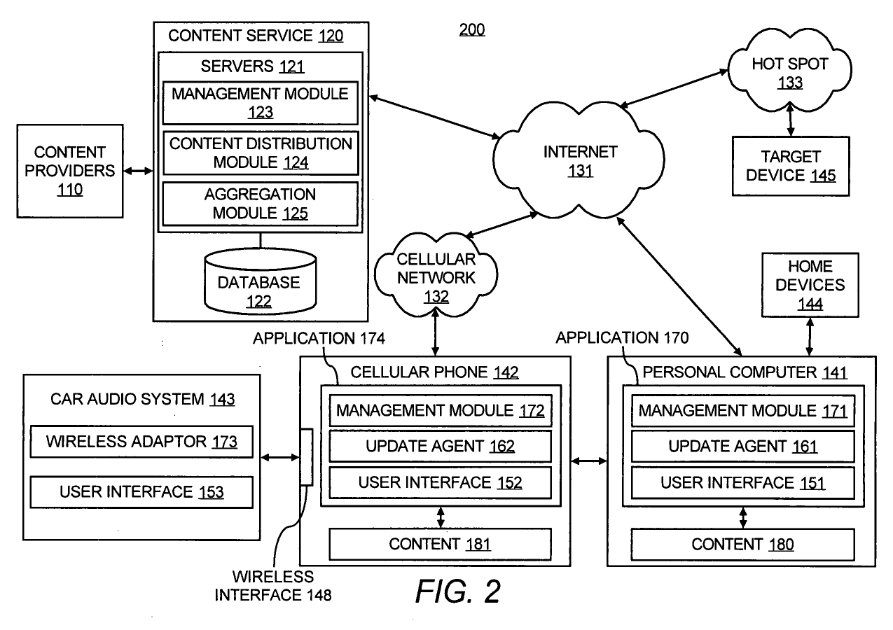

The content service 120 may provide content to the target devices 140 via the network 130. The target devices 140 may download the content from the content service 120, may receive content from one or more other target devices, such as, in a peer-to-peer arrangement, or may be operable to both download content from the content service 120 and receive content from another target device. For example, as shown in FIG. 1, target devices 141 and 142 are operable to download content from the content service 120 and may be operable to receive content from another target device. As also shown in FIG. 1, the target device 143 is operable to receive content from another target device, such as the target device 142. In this example, the target device 142 may download content from the content service 120 or receive content from the target device 141, and the target device 142 transmits content to the target device 143. The content service 120 and target devices 140 are described in further detail with respect to FIG. 2. Examples of suitable target devices 140 include but are not limited to personal computers, personal digital assistants, cellular telephones, car radio, home stereos, set-top boxes, MP3 players, portable video players, and other end-user devices.

2. Overview of Functionality and Advantages of Content Service

The system 100 provides a media experience for users without requiring a user to change conventional behavior to utilize the content service 120 providing the media experience. For example, the system 100 allows a user to play his or her selected audio content, such as music stations, talk radio, personal content, etc., on one of several target devices 140 that the user may be using at any particular time, such as a car radio in the car, a cellular phone when the user is on the go, a personal computer or home stereo at home. A target device may carry content selected by the user in a set of channels which are seamlessly available throughout the day on any one of many target devices. The system 100 manages the content and ensures the content is automatically replenished as it is consumed. Furthermore, an interface that is the same as or similar to a conventional device interface may be provided on the target devices 140, so the user may play desired content on any target device in a relatively quick and easy manner.

According to an embodiment, the content service 120 allows a user to configure one or more sets of channels for one or more of the target devices 140. Each channel is populated with content from a content provider or content provided by the user, referred to as the user's personal content. A channel is a data set of content, which may be of a particular type of content. For example, the content service 120 may make available hundreds of stations of content or individual pieces of content. Webcast radio and webcast television are some examples of stations of content. The content service 120 may provide one or more of the stations of content to users as a subscription service, where one or more stations are subscribed to by a user and the content for the stations is sent to one or more target devices for the user. In one example, one or more stations provide large or continuous blocks of Digital Millennium Copyright Act (DMCA) compliant streaming content. Some examples of individual pieces of content include single songs or albums, movies, video clips, etc. The content service 120 may provide an on-demand service where a user can purchase and download individual pieces of content.

Channels may include content of a particular type, such as a sports talk channel, a popular music channel, etc. A user may configure a set of channels, hereinafter referred to as a channel set, for example, by selecting content provided by the content service 120 and of interest to the user. The channels may include high-quality, digital content, which may be commercial-free in some instances. A channel in a channel set may also include content from a user's personal collection, such as audio files stored on the user's personal computer. This channel may be programmed by play list, genre, or artist, or any other desired category.

A user may configure several channel sets, such that the user may use different channel sets at different times. For example, a user may create a first channel set for everyday use, such as for commuting to work. This channel set may include a traffic and news channel, a sports talk radio channel, as well as other channels. The user may create a second channel set for long trips, which may include, for instance, a classic rock channel and a comedy channel.

Content for the channels may be downloaded to one or more of the target devices 140 from the content service 120. The content service 120 may also refresh a target device with new content on a substantially continuous or periodic basis. For example, after content in a channel in a target device is consumed by a user, such as after the content is played, or after content becomes stale, such as after a predetermined period of time has lapsed, the content in the channel may be replenished or replaced with new content received from the content service 120 or new content that was cached in another one of the target devices 140. This update of content on a target device may be performed automatically, and may be beneficial for target devices 140 that have limited storage for storing content, such as a PDA, phone, or other device having a relatively small amount of storage space.

In addition, the target devices 140 may each include an interface that is similar or the same as a conventional user interface widely used in at least one type of today's end user devices. Thus, a user may not be required to learn how to use the interface of a target device. Furthermore, a common interface may be provided on several target devices 140 that may be used by a single user to play content. For example, the common interface may be provided on a user's phone, personal computer, car radio, etc. Thus, the user may not need to learn how to use different interfaces for different target devices 140.

The user interfaces of the target devices 140 may emulate or include the user interfaces of conventional radio or music players with channel presets. The interfaces on the target devices 140 may provide for “one-click” channel selection, similar to clicking a channel preset button on a radio. In one example, each channel may include content populated with a type or genre of music pre-selected by the user, which allows a user to switch with one click between channels similar to switching between different radio stations on a radio. The interface may also allow a user to fast forward, rewind, or pause content.

A software application installed on a user's personal computer allows the user to manage and configure channel sets and update content on multiple target devices. Also, the content that is stored on one target device, may also be available on at least one other target device. Furthermore, the same software application or another software application may be provided on a target device that allows a user to flag songs or other content and add them to a personal wish list for purchase. U.S. patent application Ser. No. (TBD) (Attorney Docket Number BCS3804), entitled, “Granting Greater Rights to Stored Content”, incorporated by reference above describes this feature.

3. Content Service

FIG. 2 illustrates an embodiment of the system 100. The content service 120 is shown as including a management module 123, a content distribution module 124, and an aggregation module 125, in addition to the server 121 and the database 122 discussed with respect to FIG. 1. As referred herein, a module includes one or more software programs, applications, or routines stored on a computer readable medium for execution by at least one processor. Embodiments of a computer readable medium may include, but are not limited to, an electronic, optical, magnetic, or other storage or transmission device capable of providing a processor in the receiver with computer-readable instructions. Other examples of a suitable computer readable medium include, but are not limited to, a floppy disk, CD-ROM, DVD, magnetic disk, memory chip, ROM, RAM, an ASIC, a configured processor, any optical medium, any magnetic tape or any other magnetic medium, or any other medium from which a processor can read instructions. In addition, or alternatively, a module may refer to hardware configured to perform one or more functions described herein. In addition, or alternatively, a module may refer to hardware configured to perform one or more functions described herein.

The management module 123 may coordinate information between multiple users. For example, the management module 123 may receive channel configuration information from multiple users, which may include user selections of content for channels in one or more sets of channels for the multiple users. The user selections and channel sets configured by the users, may be stored in the database 122 along with additional channel configuration information added by the content service 120, such as permissions and special attributes or rules for content consumption, that is related to the user selections and configurations. The database 122 is queried subsequently to determine the content to provide to the users. In one embodiment, the management module 123 generates a web based user interface which allows a user to log into the content service 120, register with the content service 120 and set preferences, and configure channel sets.

For example, a user connects to the content service 120 via the network 130 shown in FIG. 1, which may include the Internet 131 and/or other networks shown in FIG. 2, using a personal computer 141. The user provides user information to the content service 120, which is stored in the database 122. The management module 123 may prompt a user for channel configuration information, such as a selection of a content type for each channel. For example, the user may select news, traffic, and weather for channel 1, sports talk radio for channel 2, pop music for channel 3, alternative music for channel 4, classic rock music for channel 5, and classical music for channel 6. The management module 123 stores the user selections in the database 122, and channels 1-6 are populated with content corresponding to the associated user selections, and related channel configuration information added by the content service 120, using the content distribution module 124. It should be readily understood that six channels have been described above for purposes of illustration and not of limitation. Therefore, any reasonably suitable number of channels may be available for configuration without departing from a scope of the system 100.

Alternatively, the management module 123 may prompt the user for user information, and channels may be selected for the user based on the user information. For example, the user may provide demographic information or a selection of favorite artists. Several channels may be selected for a channel set for the user based on this information. The user may select some of the channels for a channel set. Default channels may also be provided. Also, several channel sets may be configured for each user.

The content distribution module 124 sends content for channel sets to one or more target devices 140. The content distribution module 124 may determine the content to send to the target devices based on the related selected channel configuration information. For example, the content distribution module 124 retrieves channel configuration information for a selected set of channels from the database 122. In addition, the content distribution module 124 may send content for the respective channels to one or more target devices 140.

The aggregation module 125 receives, for example, content and play lists from the content providers 110 and stores the information in the database 122, such that the content may be distributed to users as needed.

4. Personal Computer User Gateway for Content Service

Several target devices 140 are shown in FIG. 2. The target devices 140 are shown as comprising a personal computer 141, a cellular telephone 142, a car audio system 143, and home devices 144. These are examples of some target devices 140 that may be used by a user. It will be apparent that other target devices 140 may also be used, such as portable content device (for instance, an MP3 player), vehicle audio systems, home media servers, etc.

Some of the target devices 140 shown in FIG. 2 are connected to the content service 120 via a network. For example, the personal computer 141 is depicted as being connected to the content service 120 via the Internet 131. The cellular telephone 142 is depicted as being connected to the content service 120 via a cellular network 132 and the Internet 131. In addition, a target device 145 is depicted as being connected to the content service 120 via a “hot spot” 133 and the Internet 131. Although not shown, additional target devices 140 may be connected to the content service 120 using one or more private networks, as opposed to a public network such as the Internet 131, and the content service 120 may provide a non-web-based content service. In one embodiment, the content service 120 includes a web service, which the user may log into using the personal computer 141 or another target device. In this embodiment, the content for the channels may be downloaded to one or more target devices 140 via the Internet 131.

The personal computer 141 may include an application 170 having a management module 171, an update agent 161, and a user interface 151. The management module 171 generally allows the user to determine and send channel configuration information for configuring selected channel sets to the content service 120. The channel configuration information may include the selection of content to place in the selected channel sets.

Examples of content that may be selected for a channel set may include genre-oriented music stations, talk content, the user's personal content, etc. Genre-oriented music content may be selected from a catalog listing a relatively large number of stations or individual content provided by the content providers 110. In addition, a single music channel may deliver a continuous set of music tracks on a target device. Talk content may also be selected from a catalog of talk content channels, which may be updated periodically, such as 15 hourly, daily or weekly. In addition, content from more than one content provider may be placed in a single channel set. The user's personal content may be stored on the personal computer 141, which the management module 171 may discover. As such, a user may sort through various content in various manners and may move large blocks of content to a channel in a channel set.

The update agent 161 generally receives content from the content service 120 and may refresh content 180 stored on the personal computer 141 on a periodic basis. For instance, the update agent 161 caches the content 180 at the personal computer 141. The content 180 may include content received from the content distribution module 124 of the content service 120.

The update agent 161 also controls the transfer of content 180 to other target devices 140. For example, when the cellular telephone 142 is connected to or otherwise interfaces with the personal computer 141, content for one or more selected channel sets may be transferred to the cellular telephone 142. In one example, the transfer of content 180 may be performed as a substantially automatic feature when the cellular telephone 142 is connected to the personal computer 141, whereby the user does not need to issue a transfer command. The update agent 161 may control the transfer of content 180 to the cellular telephone 142, such that new content may be experienced from one or more play lists.

In addition, the update agent 161 may control the transfer of content 180 to generally enable the new content to be stored on the cellular telephone 142 while staying within the limitations of the cellular telephone's 142 storage capabilities. Thus, at least a portion of the content 180 may be stored on the cellular telephone 142, which is indicated as content 181. Similarly, home devices 144, such as a home stereo or set-top box, may also receive content 180 from the personal computer 141. Instead of a personal computer 141, a server, such as a home media server, or another device may be used to receive and cache content 180 from the content service 120, without departing from a scope of the system 200.

The personal computer 141 may also include a user interface 151 that provides for “one-click” selection of channels and emulates a conventional interface. In one embodiment, the user interface 151 includes a GUI interface that a user may click to control playback and to select a channel. In addition, or alternatively, the user interface 151 may include hardware, such as buttons, wheels, keys, etc.

5. Portable Content Device

A portable content device, such as the cellular telephone 142, may include an application 174 having a management module 172, an update agent 162, and a user interface 152. The management module 172 generally allows the user to determine and send channel configuration information for configuring selected channel sets to the content service 120, in manners similar to those described above with respect to the management module 171 of the personal computer 141. In certain instances, the management module 172 may be considered optional for the application 174, since management of the application 174 may be performed by the personal computer 141.

The update agent 162 of the cellular telephone 142 generally controls updating of the content 181, which may include new content received from the content service 120 via the cellular network 132 and the Internet 131, a wireless proximity network such as Bluetooth or WiFi (802.11), or any combination thereof, as routed from the content service 120 or through the personal computer 141. For example, the content 181 may comprise new cached content received from the content service 120 as routed through the internet 131 and cellular network 132, as shown in FIG. 2. In another example, the content 181 may comprise new cached content received from the personal computer 141 via a wired connection or a wireless proximity network.

The update agent 162 of the cellular telephone 142 may also manage the receipt of content from one or both of the content service 120 and the personal computer 141. More particularly, for instance, the update agent 162 may control the receipt of one type of content from the content service 120 and another type of content from the personal computer 141. For example, the update agent 162 may control the receipt of content, such that, content required to be updated relatively frequently (hot content), such as traffic information, is received from the cellular network 132. In another example, the update agent 162 may control the receipt of content such that hot content is received from the personal computer 141 before such content expires (without going through the cellular network 132 or any other wireless telecommunication network). In addition, the update agent 162 may control the receipt of warm content and/or cold content, which are content that may be updated less frequently, to be received from the personal computer 141. In this example, the personal computer 141 may download the warm or cold content from the content service 120. Furthermore, when the cellular telephone 142 is connected to or otherwise interfaces with the personal computer 141, the warm and/or cold content may be updated on the cellular telephone 142. It will be apparent to one of ordinary skill in the art that warm content, such as news, or cold content, such as music, may also be downloaded to the cellular telephone 142 via the cellular network 132.

As shown in FIG. 2, the cellular telephone 142 is also depicted as including a wireless interface 148, which may be used to connect to the content service 120 via hot spots 133, the personal computer 141, other target devices 140, etc. The wireless network interface 148 may also be used to transfer content 181 to the car audio system 143, as shown in FIG. 2. A separate wireless interface may be used to connect to the cellular network 132 or a combined interface may be used to connect to the cellular network 132 and other devices.

Playback of the content 181 may be controlled via the user interface 152 of the cellular telephone 142. For example, the user interface 152 may include controls to enable the selection of a preset channel, to rewind, fast forward, pause, play, etc.

Although not shown, the cellular telephone 142 may comprise a device configured to provide the functionalities of multiple devices. For example, the cellular telephone 142 may include an MP3 player, PDA, camera, video player, etc.

6. Audio Device and Wireless Adaptor

A portable content device such as the cellular telephone 142 may send content to an audio device such as the car audio system 143 via the wireless interface 148 of the cellular phone 142. In addition, a wireless adaptor 173 may be used to enable communications between the cellular telephone 142 and the car audio system 143 for receiving content and for controlling playback of the content. In addition, or alternatively, a wired interface may be used to enable the communications between the cellular telephone 142 and the car audio system 143. The wireless adaptor 173 and the wireless interface 148 are further described in Ser. Nos. TBD (Attorney Docket Nos BCS03803 and BCS03802), both entitled “Wireless Adaptor for Content Transfer” which were incorporated by reference above.

According to an embodiment, the cellular telephone 142 may wirelessly stream content 181 to the car audio system 143 via the wireless adaptor 173. In this regard, the content 181 stored on the cellular telephone 142 may be played through the car audio system 143. In other embodiments, the car audio system 143 may also include a video display (not shown) that may be employed to display content 181 containing video. In any regard, a user interface 153 of the car audio system 143 may be used to control playback of the content 181. For example, the user interface 152 may include controls to enable the selection of a preset channel, to rewind, fast forward, pause, play, etc.

7. Common User Interface

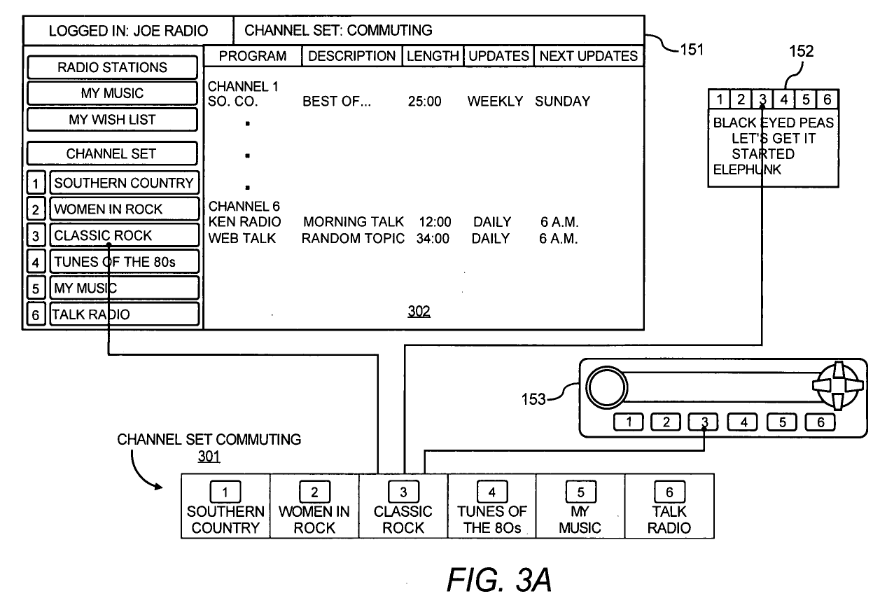

FIG. 3 illustrates embodiments of a common user interface 300 that may be provided in one or more of the target devices 140, such as the user interfaces 151-153 depicted in FIG. 2. As shown, the user interfaces 151-153 may each include a common user interface 300. More particularly, the user interfaces 151-153 are depicted as including a common user interface 300 that includes a plurality of the same or similar features. In particular, each of the user interfaces 151-153 is depicted as including a set of presets “1-6”, each of which are mapped to a channel in a channel set.

As further depicted in FIG. 3, each of the user interfaces 151-153 includes the same preset mappings for each channel set. This is illustrated by the expanded view 301 of an example of presets for a channel set named “Commuting”. The presets 1-6 are shown as respectively being mapped to channels for “Southern Country”, “Women in Rock”, “Classic Rock”, “Tunes of the 80's”, “My Music”, and “Talk”. The mappings are the same for each of the user interfaces 151-153. For example, preset 3 is mapped to “Classic Rock” for all of the user interfaces 151-153. The same mappings for the user interfaces 151-153 applies for presets 1-2 and 4-6 also. In this regard, mappings may be determined for a plurality of channel sets and the mappings for each channel set may be the same on multiple target devices 140.

The presets generally provide “one-click-selection” of a channel to play content for the channel. Furthermore, because the mapping for the presets may be the same on each target device, the user is not required to relearn the mappings for each target device.

As shown, the user interface 151 may include buttons for “Radio Stations”, “My Music”, “My Wish List” and “My Channels”. Selection of the “Radio Stations” button may list radio stations provided by the content providers 110 shown in FIGS. 1 and 2 in a display section 302 of the user interface 151. The management module 171 shown in FIG. 2 may generate channel configuration information to include, for instance, user selections of radio stations provided by the content providers 110. The content from selected radio stations may further be provided in a channel selected by the user to include the selected content.

Selection of the “My Music” button may display a list of the user's personal content in the display section 302. Selection of the “My Wish List” button may display a list of the content selected for purchase. Selection of the “Channel Set” button may display the channels in a channel set, such as shown in the display section 302. For example, the title, description, and length of content may be displayed. Also, the updates and next updates may be displayed.

The user interface 152 is shown as including the presets 1-6. Also shown are the artist, title, and album for a track currently playing on the cellular phone 142. The user interface 153 is also depicted as including the presets 1-6 and other conventional interface buttons and a display. It will be apparent to one of ordinary skill in the art that the user interfaces 151-153 may include additional features and that some of the features shown may be removed without departing from a scope of the user interfaces 151-153. Furthermore, the user interfaces 151-153 may include a software interface, such as a GUI interface, a hardware interface, such as buttons on an audio system, portable end-user device or personal computer, or a combination of both hardware and software interfaces. In addition, information other than what is shown in FIG. 3 may be displayed in response to the selection of different options. For example, album art or video clips may be displayed for artists.

8. Examples of Channel Content in a Second Channel Set

FIG. 3A, in addition to showing a common user interface among a plurality of target devices, provides one example of a channel set called “Commuting” for a user. A user may have multiple channel sets. FIG. 3B illustrates an example of content for a second channel set, named “Commuting 2”, for the user. Channels 350 in the Commuting 2 channel set include Rock, Hot Content, Sports, Jazz, Beatles and Recently New.

FIG. 3B also shows content 351 for the channels 350. For example, the content for channels 1 and 4, named Rock and Jazz, respectively, may include content that the user is required to listen to in a strict sequence. For example, the content provider for the Rock channel sends a playlist to the content service 120 along with the content. The content for the playlist is transmitted to a target device for the user in a format that only allows the user to listen to the content as provided. In one embodiment, the content provider may allow the user to pause, rewind or possibly fast forward through the content, and in other embodiments, the user may not be able to perform one or more of those functions.

Content for a channel may be provided by more than one content provider. For example, the Hot Content channel may include national news content and international news content provided by one content provider and traffic and weather content provided by a different, regional content provider. Channels 5 and 6, named Beatles and Recently New, respectively, may include the user's personal content. This content and possibly content for other channels may be listened to out of sequence or paused. The user may navigate through the content using a user interface of a target device.

For target devices with limited memory, which may not have the storage capacity to hold all the content desired by a user, new content may be appended to a channel list as content is consumed from the beginning, such as through automatic updates performed when the target device is connected to another target device caching the content or when the target device with limited memory is connected to a network to receive the new content from the content service 120.

9. Hot Content

As described above, at least some of the content for a user may be hot content. Hot content comprises content that becomes dated if the content is not updated within a predetermined period of time or if an expiration date and/or time has passed. The predetermined period of time or a specific expiration date and/or time may be specified by a user or another entity. Hot content may become dated more quickly than other content and typically needs to be updated more frequently than other content. One example of hot content is traffic and weather content, such as shown in the Hot Content channel in FIG. 3B. The traffic and weather content may become dated in a short time period, and the user may desire to receive traffic and weather updates every 10-15 minutes, especially when commuting. Another example of hot content is stock quotes. Examples of updating the hot content on a target device are as follows. In a first example, the hot content is preemptively updated based on a time period assuming the user could switch to the channel carrying the hot content at any time. This has the lowest latency, but the highest use of the cellular network 132 or another network, such as the Internet 131. In a second example, the hot content is preemptively updated when there is user activity or a historical pattern that suggests the user will be interested in the hot content soon. This reduces use of the network but may increase the chance of a poor user experience or increased latency. In a third example, rather than continually loading the hot content, the hot content is streamed from the content service 120 or the content provider 110 over the network at the instant the user selects that hot content. Hot content may be updated using other procedures as would be apparent to one of ordinary skill in the art.

Warm content is content that a user may desire to be frequently or periodically updated, but warm content may be updated less frequently than hot content. Examples of warm content may include local, national or international news. The user may desire that the news be updated every four hours or twice daily. Also, daily talk shows may be updated daily. Top 40 songs may be updated daily or weekly.

Cold content is content that may become dated infrequently or may never become dated. For example, classic rock songs or Beatle's songs may not become dated.

According to an embodiment, the system 100 is operable to update hot content when a target device is connected to the content service 120 via a network. For example, referring to FIG. 2, the cellular phone 142 may receive hot content, such as traffic reports, from the content service 120 via the cellular network 132 or another network every 10 minutes during morning and evening commute times. The cellular phone 142 may receive hot content from the personal computer 141, however, in certain situations, such as during commuting, the cellular phone 142 may not be able to connect to the personal computer 141, for example, located at the user's home. Thus, the cellular phone 142 may receive the hot content via the cellular network 132 or a hot spot. Also, the size of the hot content may be small, e.g., 2-4 minutes of audio content provided in compressed, voice-quality format, so it still may be economical to receive the hot content when the network provider charges a fee, such as an air-time fee.

It will be apparent to one of ordinary skill in the art that one or more of hot content, warm content, or cold content may be received directly from the content service 120 via a network or from a target device storing the content. Furthermore, the target device receiving the content may determine the cheapest means for obtaining the content. For example, the cellular phone 142 may determine whether content may be received from the personal computer 141 or the content service 120 via a no-charge network connection first.

According to an embodiment, hot content distribution may be personalized for a user. For example, a user may indicate in channel configuration information sent to the content service 120, user preferences for determining the hot content to be provided to the user and for determining transmission preferences for the hot content.

For example, the content service 120 uses user preferences specifying parameters for determining hot content to filter the content provided by the content providers 110 to determine the hot content for the user. One example of personalizing hot content may include determining a location of a user and transmitting hot content to the user based on the location. Location may be geographic location. Location may be determined from GPS or other known techniques and transmitted to the content service 120. The content service 120, then transmits hot content, such as traffic and weather content, relevant to the user's location. The user preferences may specify that the location information is to be received from the user to determine the hot content.

In another example, the location information may be predetermined, which may include routes traveled when commuting or city of residence and job location. The predetermined location may be specified in the user preferences, and the content service 120 sends hot content and updates for hot content for the predetermined location.

Also, the hot content may be transmitted to the target device at the periodicity specified in the user preferences. Alternatively, the user may initiate the transmission of hot content to the target device. For example, when the user hits preset 2 on the user interface of the car audio system 143, the cellular phone 142, which is streaming content to the car audio system 143, receives a traffic update from the content service 120. The traffic information may be fed into a navigation system for determining routes and for displaying the information. A user may also specify that the triggering of the transmission and loading of hot content or updates for hot content is caused by the presence of new, hot, content or may be based on time of day or other events.

In one embodiment, the target device receives an update for the hot content and caches the update until the user plays the update. For example, the cached hot content is played when the user hits a preset of a channel including the hot content. Before the hot content is played, the target device may determine whether the update is expired. Expiration may be based on a date and time or lapse of a predetermined period of time or based on another event. If the hot content update is expired, the target device provides a new update for the user. This may include requesting a new update from the content service 120 or from another target device.

Warm and/or cold content may similarly be personalized. The user may specify the content they want, which may include personal content or content from the content service 120, and the content is loaded into the target device through a wired or wireless connection.

The personalizing of hot content makes it fast and easy for a user to obtain relevant, up-to-date information. For example, the user sets preferences specifying that one or more target devices is to receive each morning, updated local and international news, stock quotes for securities in the user's portfolio, sports scores for the user's favorite teams, and traffic and weather information. All this content may be provided on a single channel, so the user can receive the content through a single-click of a channel preset. Furthermore, the content may be stored on multiple target devices and mapped to the same channel on each target device, so the user can quickly obtain desired information using any one of the multiple target devices.

10. Method Embodiments

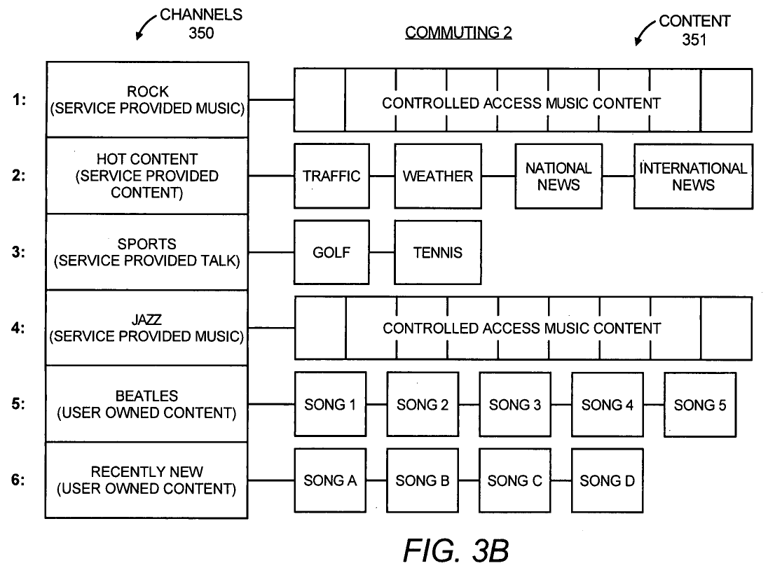

FIGS. 4-7 illustrate methods 400-700 for automatically updating content at a target device. The methods 400-700 are described with respect to FIGS. 1-3 by way of example and not of limitation. It will thus be apparent to one of ordinary skill in the art, that the methods 400-700 may be performed with systems other than those depicted in FIGS. 1-3. Furthermore, the steps of the methods 400-700 are described as being performed by the personal computer 141 or the cellular phone 142 shown in FIG. 2 by way of example. Many of the steps may be performed by a target device other than described as would be apparent to one of ordinary skill in the art.

With regard to the method 400 shown in FIG. 4, at step 401, a target device, such as the personal computer 141 shown in FIG. 2, sends channel configuration information to the content service 120. The channel configuration information may include user selections of content for channels in one or more sets of channels. User selections may include selections of content provided by the content providers 110. Examples of content provided by the content providers 110 may include music, video and other media and data. In one example, content providers 110 may provide relatively large or continuous blocks of music or talk radio content. Several different categories of music and talk radio also may be provided. In this example, a user may select different categories of music or talk radio for different channels in a channel set. In other examples, the channel configuration information may include user demographic information and channels are selected for a user based on the user demographic information. Also, a channel or a channel set may include content from two or more categories, two or more content providers, or from a user's personal content.

At step 402, the personal computer 141 receives content for the channels in the one or more channel sets, and stores the content at step 403. At step 404, the personal computer 141 may transmit at least some of the content stored at the personal computer 141 to another target device, such as the cellular telephone 142. The amount and type of content transmitted to the target device may be based, for instance, upon the storage capacity of the cellular phone 142 or other factors, such as, the amount of time elapsed from when a previous transmission of content occurred.

At step 405, the personal computer 141 may automatically update the content stored at the cellular telephone 142. For example, the cellular telephone 142 may connect to the personal computer 141 at various times to receive content or the cellular telephone 142 may already be connected to the personal computer 141, such as during charging, and the personal computer 141 initiates the update. The personal computer 141 may receive a report from the cellular telephone 142 indicating the content that has been consumed and/or the content that is stale. In response, the personal computer 141 may send content to the cellular telephone 142 to replace the consumed content and/or the stale content. In addition, or alternatively, the user may select the content in the cellular telephone 142 to replace with new content during the update, or the user may select to replace the entire content. Thus, the personal computer 141 may cache the content for updates or transmission to one or more other target devices 140. Alternatively, however, content may be sent from the content service 120 to a target device other than the personal computer 141. For example, content, such as hot content, may be sent directly to the cellular telephone 142 from the content service 120 via the cellular network 132.

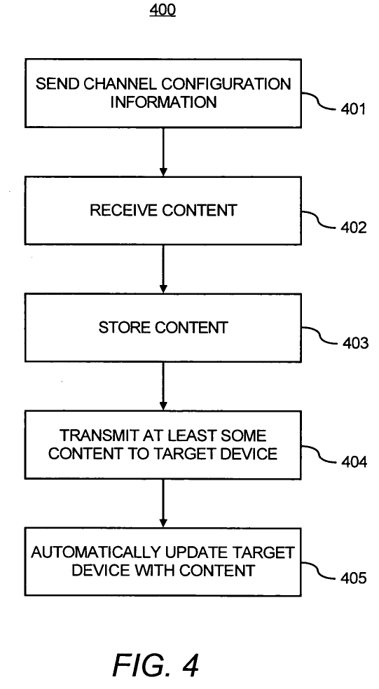

FIG. 5 illustrates the method 500 for automatically updating content on a target device. One or more steps of the method 500 may be substeps of step 405 of the method 400. In one embodiment, the steps of the method 500 are performed when the cellular phone 142, shown in FIG. 2, is connected to the personal computer 141 via an interface, such as a USB port, and the storage on the cellular phone 142 is accessible by the personal computer 141 and the application 174 of the cellular phone 142 is passive.

At step 501, the personal computer 141 shown in FIG. 2 receives channel configuration information and administration files from the cellular phone 142. The administration files may include a report including one or more of the content stored in the phone, the content stored in the phone and already consumed by the user, and the content stored in the phone that has become stale or information for determining whether content has become stale. The administration files may also include a playpoint for some channels, which is the point where consumption ended for a channel. The administration files may be in the form of log files including a record of a user's consumption. The log files may be used to determine the content that has been consumed and for paying the content providers 110.

At step 502, the personal computer 141 sends the administration files to the content service 120. The content service 120 determines the content to send to the personal computer 141 and the cellular phone 142 based on the administration files and the channel configuration information for the user. The personal computer 141 receives and stores the content. It should be noted that a phone update generally does not require the personal computer 141 to be connected to the content service 120. The personal computer 141 caches content from the content service 120, so the cellular phone 142 may be updated when the personal computer 141 is not connected to the content service 120. In certain situations, the personal computer 141 may need to be connected to the content service 120 to perform an update for the cellular phone 142. For example, during initial setup the personal computer 141 may need to be connected to the content service 120 to establish a security environment. In another example, if large amounts of data on the cellular phone 142 become corrupted, a connection to the content service 120 may be needed to repair the data.

At step 503, the personal computer 141 writes new channel configuration information and/or administration files to the cellular phone 142 if the channel configuration information or the administration files changed.

At step 504, the personal computer 141 determines the content that is stored on the cellular phone 142, for example, based on the administration files received from the cellular phone 142.

At step 505, the personal computer 141 determines the memory space available on the cellular phone 142 for storing more content, for example, based on the administration files received from the cellular phone 142.

At step 506, the personal computer 141 determines the content to be copied to the cellular phone 142, for example, based on the consumption indicated in the administration files received from the cellular phone 142.

At step 507, the personal computer 141 deletes content no longer needed on the cellular phone 142, such as consumed content and/or stale content.

At step 508, the personal computer 141 copies new content determined at step 506 to the cellular phone 142.

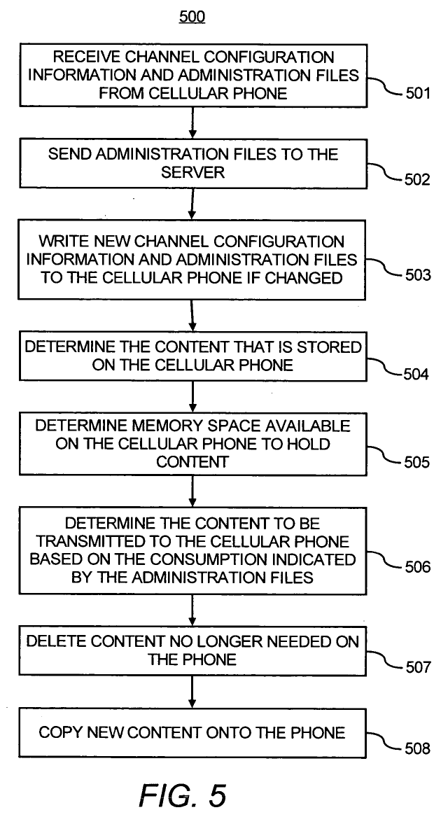

FIG. 6 illustrates the method 600 for updating content on a target device, such as the cellular phone 142. At step 601, the application 174 for the cellular phone 142 reads administration files written to the cellular phone 142 by the personal computer 141, for example, at step 503 of the method 500.

At step 602, the application 174 merges previous channel playpoint information with new information from the content service 120. For example, the playpoint information may include the point on a playlist to start playing content from the playlist based on past user consumption. The content for the playlist may be provided in a channel. The playpoint may be specified in the administration files.

At step 603, the application 174 shows the previously selected channel and playing paused at the playpoint on the user interface 152.

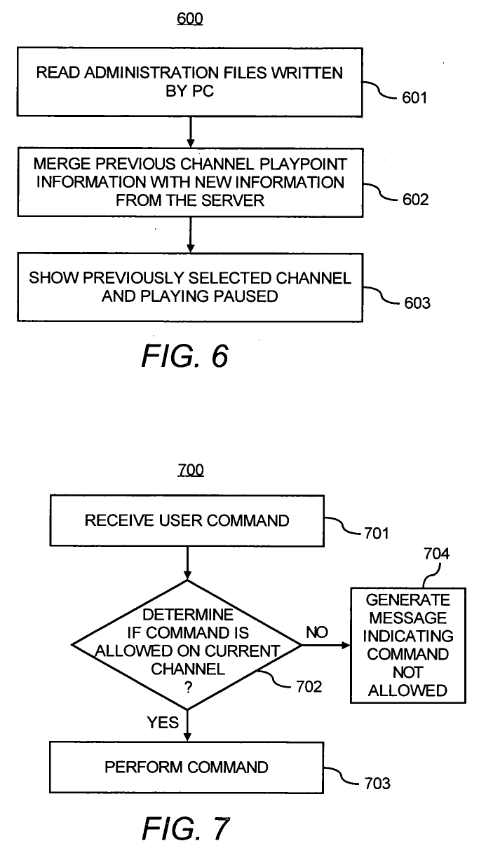

FIG. 7 illustrates the method 700 for controlling the consumption of content stored on a target device based on user input. At step 701, the application 174 for the cellular phone 142 receives a user command based on user input via the user interface 152. For example, the user interface includes a GUI fast forward button that is clicked by the user for generating a fast forward command.

At step 702, the application 174 determines whether the command is allowed for the channel. For example, the fast forward command may not be allowed by the content provider for a particular channel but it is allowed for a channel including personal content.

At step 703, the command is performed if allowed. If the command is not allowed, then the user interface 152 may generate a message indicating the command is not allowed for the channel at step 704. The steps of the method 400 may be repeated when a new command is received.

11. Hardware Platform

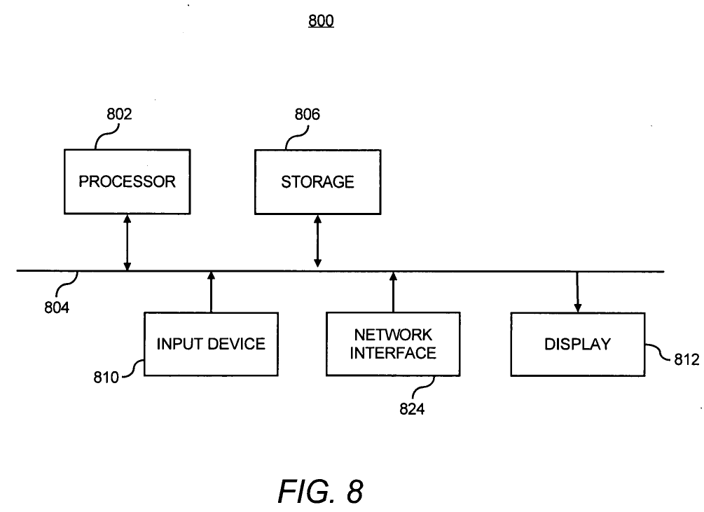

FIG. 8 illustrates a block diagram of a computer system 800 which may be used as a hardware platform for one or more of the components of the system 100, such as the personal computer 141, server 121, cellular telephone 142, as well as one or more of the other components depicted in FIGS. 1-3A. The computer system 800 is a simplified block diagram, and the components of the system 100 may include many more elements not shown or some of the components may not include all the elements shown in FIG. 8.

The computer system 800 may include a processor 802, which provides a platform for executing software. The computer system 800 also includes a storage 806, which may include Random Access Memory (RAM) where software is resident during runtime. The storage 806 may also include one or more other types of memory such as ROM (read only memory), EPROM (erasable, programmable ROM), EEPROM (electrically erasable, programmable ROM) and data storage, such as hard disks, etc., may be used. For example, the storage 806 may include one or more hard disk drives and a removable storage drive, such as a floppy or flash memory.

A user may interface with the computer system 800 through an input device 810, such as, a keyboard, buttons, a mouse, a stylus, and the like. A display 812 and a network interface 824 may also be included. In addition, data may be transmitted between components via a bus 804.

One or more of the steps of the methods 400-700 and other steps described herein and software described herein may be implemented as software embedded or stored on a computer readable medium, such as the storage 806, and executed by the processor 802. The steps may be embodied by a computer program, which may exist in a variety of forms both active and inactive. For example, there may exist as software program(s) comprised of program instructions in source code, object code, executable code or other formats for performing some of the steps when executed. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method comprising:
sending channel configuration information to a content service, wherein the content service determines content to be provided in each channel of a set of channels using the channel configuration information;
receiving content for the channels in the set of channels at a first target device;
storing the content for the channels;
transmitting at least some of the content to a second target device; and
automatically updating content stored at the second target device with content received from the content service.

2. The method of claim 1, wherein automatically updating content stored at the second target device further comprises:
transmitting content to the second target device from the first target device, wherein the transmitted content replaces content consumed at the second target device.

3. The method of claim 1, wherein automatically updating content stored at the second target device further comprises:
transmitting content to the second target device from the first target device, wherein the transmitted content replaces stale content stored at the second target device, wherein stale content includes at least one of content for which a predetermined period of time has lapsed and content having an expiration data and time that has passed.

4. The method of claim 1, wherein automatically updating content stored at the second target device further comprises:
receiving a report from the second target device;
determining content to send to the second target device based on the report; and
transmitting the determined content to the second target device.

5. The method of claim 4, wherein the report indicates consumption of content for each channel at the second target device, and determining content to send to the second target device further comprises determining an amount of content to send to the second target device based on at least one of the consumption and storage capacity of the second target device.

6. The method of claim 4, wherein the report indicates whether content stored at the second target device is stale, and determining content to send to the second target device further comprises determining content to send to the second target to replace the stale content.

7. The method of claim 1, wherein automatically updating content stored at the second target device further comprises:
automatically updating the content stored at the second target device when the second target device is re-connected to the first target device at a later time subsequent to the transmitting the at least some content.

8. The method of claim 1, wherein automatically updating content stored at the second target device with content received from the content service further comprises:
automatically updating the content stored at the second target device with content stored at the first target device.

9. The method of claim 1, wherein automatically updating content stored at the second target device with content received from the content service further comprises:
receiving new content from the content service without connecting to the first target device.

10. The method of claim 1, wherein the configuration information comprises channel configuration information for a plurality of sets of channels, such that the first target device is operable to receive content for the plurality of sets of channels.

11. The method of claim 10, further comprising:
determining a set of channels from the plurality of sets of channels to be available for consumption at one or more of the first and second target devices.

12. The method of claim 1, further comprising:
providing a common user interface for the first and second target devices, wherein the common user interface provides one-click selection of a channel from the set of channels for playing content in the selected channel.

13. The method of claim 12, wherein the common user interface includes a plurality of presets, each preset mapped to a channel in the set of channels.

14. A device operable to receive content from a content service, the device comprising:
storage operable to store content received from the content service, wherein the content includes content for a plurality of channels in a channel set, wherein the device is operable to transmit at least some of the stored content to a second device;
a processor operable to determine content stored in the second device that was consumed and is further operable to automatically update the consumed content with new content when the second device is connected to the device.

15. The device of claim 14, wherein the processor is operable to determine the content consumed for each channel, and is further operable to automatically update the consumed content for each channel with new content for the respective channel.

16. The device of claim 15, wherein each channel comprises content associated with a particular category.

17. The device of claim 15, wherein the new content for the automatic update is received from the content service and cached in the device, and the new content is transmitted to the second device when the second device is connected to the device.

18. The device of claim 14, wherein the device is further operable to send channel configuration information to the content service, wherein the content service determines content provided in each channel of the set of channels using the channel configuration information, the content in each channel including content from one or more content providers providing content to the content service.

19. The device of claim 18, wherein the configuration information comprises channel configuration information for a plurality of sets of channels, such that the first target device is operable to receive content for the plurality of sets of channels.

20. The device of claim 14, further comprising a common user interface, wherein the common user interface is also used in the second device, the common user interface providing one-click selection of a channel from the set of channels for playing content in the selected channel.

21. The device of claim 19, wherein the common user interface includes a plurality of presets, each preset mapped to a channel in the set of channels.

22. A first target device operable to receive content from a content service and connect to a second target device to transfer content to the second target device, the first target device comprising:
means for sending channel configuration information to the content service, wherein the content service determines content to be provided in each channel of a set of channels using the channel configuration information;
means for receiving content for the channels in the set of channels;
means for storing the content for the channels;
means for transmitting at least some of the content to the second target device; and
means for automatically updating content stored at the second target device with content received from the content service.

23. The first target device of claim 21, further comprising:
a common user interface means for receiving input from a user, wherein the common user interface means is also used in the second target device, the common user interface means providing one-click selection of a channel from the set of channels for playing content in the selected channel.

24. A computer readable medium storing one or more computer programs including code that when executed causes a computer to perform the following:
generating channel configuration information from user input, wherein the channel configuration is transmitted to a content service and the content service determines content provided in each channel of a set of channels using the channel configuration information;
receiving content for the channels in the set of channels;
storing the content for the channels;
transmitting at least some of the content to the second target device; and
automatically updating content stored at the second target device with content received from the content service.

25. The computer readable medium of claim 24, wherein the code when executed causes the computer to further generate:
a common user interface receiving input from a user, wherein the common user interface is also used in the second target device, the common user interface providing one-click selection of a channel from the set of channels for playing content in the selected channel.
